(19) United States
(12) Patent Application Publication
(10) Pub. No.: US 2008/0270268 A1
(43) Pub. Date: Oct. 30, 2008

(54) System and method for service loss analysis and reporting

(75) Inventors: Seth Ryan Pacha, Metamora, IL (US); Robert James Sapp, Goodfield, IL (US); Aaron Andrew Evans, East Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/790,724

(22) Filed: Apr. 27, 2007

(51) Int. Cl. G06Q 10/00

(52) U.S. Cl. 705/28

(57) ABSTRACT

A method for analyzing service loss in inventory environments comprises receiving sales order data associated with a plurality of warehouses, the sales order data including at least one sales order line that includes data indicative of a customer requirement associated with a part number. The method also includes analyzing sales order lines that are not filled by a predetermined completion date based on a predetermined service loss hierarchy and determining a cause of service loss for one or more sales order lines that are not filled by a predetermined completion date based on the analysis. The method further includes generating a service loss report summarizing the cause of service for the one or more sales order lines that are not filled by a predetermined completion date.

### TECHNICAL FIELD

The present disclosure relates generally to inventory management systems and, more particularly, to systems and methods for service loss analysis and reporting in supply chains that include multiple warehouse environments.

### BACKGROUND

Supply chain management is an integral part of any organization that relies on the production, sale, and distribution of products associated with an inventory management environment. Supply chain management refers to any system of processes that allows an organization to control the manufacture and distribution of goods and coordination of services to meet a customer requirement for a product or service for sale. Businesses that can effectively adapt their supply chain to meet customer expectations while controlling costs may have an increased market position over competitors with less sophisticated supply chain management capabilities.

One measure for evaluating the performance of a supply chain is service level. Service level refers to the ability of a supply chain to meet customer requirements and is typically expressed as the ratio or percentage of the customer requirements satisfied with respect to the total number of customer requirements received. Organizations typically establish a minimum target service level and adjust supply chain parameters to strike an appropriate balance between service level and inventory management costs. Thus, in order to effectively manage a supply chain, a system for analyzing and reporting service loss in inventory management environments may be required.

One method for monitoring service level in a supply chain environment is described in U.S. Patent Publication No. 2006/0047559 (“the '559 publication”) to Jacoby et al. The '559 publication discloses a method for optimizing target stock levels for a product inventory based on a desired customer service level. The service level is based on historical demand data and may be established as a target percentage of customer orders that can be completed according to the customer requirements. The method of the '559 publication analyzes the service level for each part number and adjusts the target stock level to maintain the desired customer service level. By increasing target stock levels, the method of the '599 attempts to ensure that enough saleable material is available to limit any deficiencies created by supply chain problems.

Although the system of the '559 publication may be configured to adjust target inventory stock levels based on historical demand and forecasting models in order to maintain a customer service level, it does not identify or analyze any underlying causes that may be associated with a decrease in customer service level.

The presently disclosed system and method for service loss analysis and reporting are directed to overcoming one or more of the problems set forth above.

### SUMMARY OF THE INVENTION

In accordance with one aspect, the present disclosure is directed toward a method for analyzing service loss in inventory environments. The method may include receiving sales order data associated with a plurality of warehouses. The sales order data may include at least one sales order line that includes data indicative of a customer requirement associated with a part number. The method may also include analyzing sales order lines that are not filled by a predetermined completion date based on a predetermined service loss hierarchy and determining a cause of service loss for one or more sales order lines that are not filled by a predetermined completion date based on the analysis. The method may further include generating a service loss report summarizing the cause of service for the one or more sales order lines that are not filled by a predetermined completion date.

According to another aspect, the present disclosure is directed toward a method for inventory management based on service loss. The method may include receiving sales order data associated with a plurality of warehouses, the sales order data having at least one sales order line that includes data indicative of a customer requirement associated with a part number. The method may also include determining a status of each sales order line based on the sales order data. Service loss may be determined as a ratio of a total number of sales order lines that are not filled on or before a predetermined completion date to the total number of received sales order lines, and an operational aspect of the supply chain may be adjusted if the service loss ratio exceeds a predetermined threshold level.

In accordance with yet another aspect, the present disclosure is directed toward an inventory management system comprising a service loss analysis interface and a service loss reporting interface. The service loss analysis interface may be configured to receive sales order data associated with a plurality of warehouses, the sales order data having at least one sales order line that includes data indicative of a customer requirement associated with a part number. Sales order lines that are not filled by a predetermined completion date may be analyzed based on a predetermined service loss hierarchy. The service loss analysis interface may determine a cause of service loss for one or more sales order lines that are not filled by a predetermined completion date based on the analysis. The service loss reporting interface may be configured to prompt a user to select one or more service loss reporting formats and a service loss reporting frequency, receive the user selections, and generate a service loss report in accordance with the user selections. The service loss report may summarize the cause of service for one or more sales order lines that are not filled by the predetermined completion date.

### BRIEF DESCRIPTION OF THE DRAWINGS

FIG. 1 illustrates an inventory management environment consistent with the disclosed embodiments;

FIG. 2 provides a schematic illustrating certain components of the inventory management environment of FIG. 1;

FIG. 3 provides a table depicting an exemplary loss reason hierarchy consistent with certain disclosed embodiments; and

FIG. 4 provides a flowchart depicting an exemplary method for service loss analysis and reporting in accordance with the disclosed embodiments.

### DETAILED DESCRIPTION

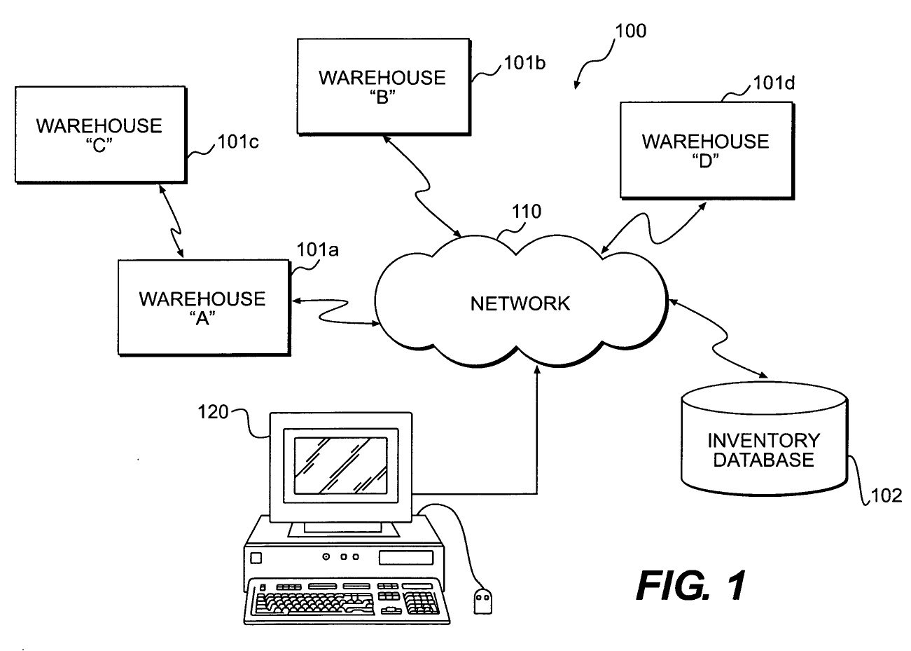

FIG. 1 illustrates an inventory management environment 100 in accordance with the disclosed embodiments. Inventory management environment 1.00 may include any environment that comprises a plurality of subsystems that cooperate to manage a supply chain. For example, inventory management environment 100 may include one or more components suitable for monitoring operational aspects associated with a supply chain, analyzing supply chain performance, and reporting data indicative of the supply chain performance to an inventory manager. As illustrated in FIG. 1, inventory management environment 100 may include a plurality of inventory warehouses 101a-d for maintaining, storing, and distributing a plurality of products within a supply chain. Inventory management environment 100 may also include an inventory management system 120 communicatively coupled to one or more inventory warehouses 101a-d via a communication network 110. It is contemplated that additional, fewer, and/or different components may be associated with inventory management environment 100. For example, inventory management environment may include an inventory database 102 for collecting and maintaining inventory record data associated with each of inventory warehouses 101a-d.

Inventory warehouses 101a-d may each include any type of facility in which a plurality of products may be stored and maintained. Products, as the term is used herein, may include any physical or virtual element that may be used in connection with the performance of a business task. Non-limiting examples of physical products may include machines or machine parts or accessories such as, for example, electronic hardware or software; implements; traction devices such as tires, tracks, etc.; transmissions; engine parts or accessories; fuel; or any other suitable type of physical product. Non-limiting examples of virtual products may include inventory data, product documentation, software structures, software programs, financial data or documents such as stock records, or any other type of informational or data product. Inventory warehouses 101a-d may include, for example, a parts depot, a product showroom, a document storage facility, a retail center, a regional distribution center, a virtual (e.g., web-based or Internet) retailer, or any other type of facility suitable for storing physical and/or virtual products.

Each product associated with inventory warehouses 101a-d may be assigned a unique part identification number. The part identification number may facilitate the tracking of each part through the supply chain. A part identification number may include, for example, a numeric, alphabetic, alphanumeric, or symbolic code that may be used to identify and track the part number within inventory warehouses 101a-d. Part numbers may also be associated with RFID devices and/or coded indicia systems (e.g., barcodes, etc.) that may be compatible with electronic scan technology.

Communication network 110 may include any wired and/or wireless communication system suitable for data transmission such as, for example, satellite, cellular, point-to-point, point-to-multipoint, multipoint-to-multipoint, Bluetooth, RF, Ethernet, fiber-optic, coaxial, and/or waveguide communications. According to one embodiment, communication network 110 may include the Internet or a work-site intranet that communicatively connects one or more computer systems associated with divisions or entities of an organization, thereby facilitating data communication therebetween. Alternatively and/or additionally, the network may embody a direct data link for communicatively coupling one or more devices directly to inventory management system 120 and may include serial, parallel, USB, Ethernet, fiber-optic, fire-wire, Bluetooth, or any other type of transmission medium suitable for direct transfer of information.

Inventory management system 120 may include any device or software program configured to monitor and record inventory data associated with inventory management environment 100. For example, the inventory management system 120 may be communicatively coupled to one or more inventory warehouses 101a-d via communication system. 110. Inventory management system 120 may collect inventory data associated with each warehouse, monitor and control the flow of inventory between or among each warehouse, and adapt supply chain resources to ensure the appropriate operation of inventory management environment 100.

Inventory management system 120 may embody a processor-based system on which processes and methods consistent with the disclosed embodiments may be implemented. For example, inventory management system 120 may be a stand-alone computer system on which an inventory management software suite may be installed. Accordingly, inventory management system 120 (and/or software associated therewith) may be configured to collect inventory record data associated with each inventory warehouse 101a-d, analyze the collected data to determine whether the supply chain is operating appropriately, identify problems associated with the supply chain, isolate possible operational aspects of the supply chain that may be the cause of the problems, and generate a report that summarizes the analysis. Processes and methods associated with inventory management system 120 are described in further detail below.

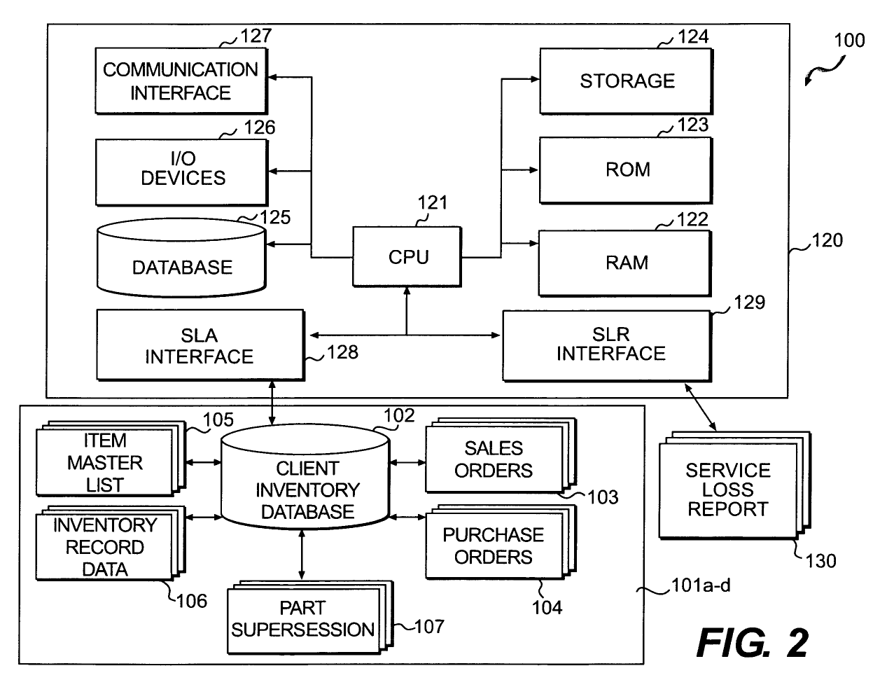

FIG. 2 provides a schematic illustrating certain components of inventory management environment 100 of FIG. 1. As illustrated in FIG. 2, inventory management system 120 may include one or more hardware and/or software components configured to execute software programs, such as software for managing inventory management environment 100, inventory monitoring software, or inventory transaction software.

Inventory management system 120 may include one or more hardware components such as, for example, CPU 121, a random access memory (RAM) module 122, a read-only memory (ROM) module 123, a storage system 124, a database 125, one or more input/output (I/O) devices 126, and a communication interface 127. Alternatively and/or additionally, inventory management system 120 may include one or more software components such as, for example, a computer-readable medium including computer-executable instructions for performing methods consistent with the disclosed embodiments. It is contemplated that one or more of the hardware components listed above may be implemented using software. For example, storage 124 may include a software partition associated with one or more other hardware components of inventory management system 120. Inventory management system 120 may include additional, fewer, and/or different components than those listed above. Accordingly, it is understood that the components listed above are exemplary only and not intended to be limiting.

CPU 121 may include one or more processors, each configured to execute instructions and process data to perform one or more functions associated with inventory management system 120. As illustrated in FIG. 2, CPU 121 may be communicatively coupled to RAM 122, ROM 123, storage 124, database 125, I/O devices 126, and communication interface 127. CPU 121 may be configured to execute sequences of computer program instructions to perform various processes, which will be described in detail below. The computer program instructions may be loaded into RAM 122 for execution by CPU 121.

RAM 122 and ROM 123 may each include one or more devices for storing information associated with an operation of inventory management system 120 and/or CPU 121. For example, ROM 123 may include a memory device configured to access and store information associated with inventory management system 120, including information for identifying, initializing, and monitoring the operation of one or more components and subsystems of inventory management system 120. RAM 122 may include a memory device for storing data associated with one or more operations of CPU 121. For example, ROM 123 may load instructions into RAM 122 for execution by CPU 121.

Storage 124 may include any type of mass storage device configured to store information that CPU 121 may need to perform processes consistent with the disclosed embodiments. For example, storage 124 may include one or more magnetic and/or optical disk devices, such as hard drives, CD-ROMs, DVD-ROMs, or any other type of mass media device.

Database 125 may include one or more software and/or hardware components that cooperate to store, organize, sort, filter, and/or arrange data used by inventory management system 120 and/or CPU 121. For example, database 125 may include historical data such as, inventory demand data and/or past customer order data. Trends may be recorded and analyzed to adjust one or more aspects to improve an inventory control process, which may help reduce inventory management errors, such as over- or under-stocking or inventory. It is contemplated that database 125 may store additional and/or different information than that listed above.

I/O devices 126 may include one or more components configured to communicate information with a user associated with inventory management system 120. For example, I/O devices may include a console with an integrated keyboard and mouse to allow a user to input parameters associated with inventory management system 120. I/O devices 126 may also include a display including a graphical user interface (GUI) for outputting information on a monitor. I/O devices 126 may also include peripheral devices such as, for example, a printer for printing information associated with inventory management system 120, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Communication interface 127 may include one or more components configured to transmit and receive data via a communication network, such as the Internet, a local area network, a workstation peer-to-peer network, a direct link network, a wireless network, or any other suitable communication platform. For example, communication interface 127 may include one or more modulators, demodulators, multiplexers, demultiplexers, network communication devices, wireless devices, antennas, modems, and any other type of device configured to enable data communication via a communication network.

Inventory management system 120 may also include a service loss analysis (SLA) interface 128 and a service loss reporting (SLR) interface 129 for communicating with one or more client inventory databases 102 and users of inventory management system 120, respectively. According to one embodiment, SLA and SLR interfaces may each include software applications that, when executed by CPU 121, may be configured to facilitate communication with one or more systems or entities with which they are connected.

SLA interface 128 may include a software application that is adapted to receive/collect data from a client inventory database 102 associated with one or more inventory warehouses 101a-d and monitor one or more aspects associated with the collected data. SLA interface 128 may also be configured to analyze the collected data to track the service loss level and determine or identify a cause associated with the service loss event. SLA interface 128 may be configured to periodically query a client inventory database 102 for inventory record data associated with a supply chain. Alternatively and/or additionally, SLA interface may be configured to automatically receive inventory record data from client inventory database 102.

SLR interface 129 may include a software application configured to prompt a user to select one or more reporting options for reporting service loss analysis data from SLA interface 129 to a user of inventory management system 120. For example, SLR interface 129 may include a graphical user interface that provides an interactive display, which allows a user to select from a plurality of predetermined report formats. Once a report is selected by a user, SLR interface 129 may compile the requested report data and output a service loss report via one or more I/O devices 126. Although SLA and SLR interfaces are illustrated as separate interfaces, it is contemplated that SLA and SLR interfaces may be included together as part of an integrated service loss analysis program associated with inventory management system 120.

Client inventory database 102 may include an electronic repository for inventory data associated with inventory environment 100. As such, client inventory database 102 may be included as part of an inventory management server or centralized inventory mainframe. As such, client inventory database 102 may collect and store inventory record data associated with each of a plurality of inventory warehouses 101a-d. For example, each of inventory warehouses 101a-d may automatically and/or periodically provide “up-to-date” inventory information to client inventory database 102. Alternatively and/or additionally, client inventory database 102 may automatically receive inventory information from one or more inventory warehouses 101a-d in response to a change in the inventory record data associated with a respective warehouse.

Client inventory database 102 may be included as part of a centralized inventory management server that receives and stores data for each of inventory warehouses 101a-d. Alternatively, each of inventory warehouses 101a-d may include separate, stand-alone inventory management computers, each including its own client inventory database 102. As such, a plurality of inventory warehouse computers (one associated with each inventory warehouse 101a-d) may be communicatively coupled to SLA interface 128 of inventory management system 120 via communication network 120, thereby facilitating access to inventory record data between each client inventory database 102 and inventory management system 120.

Client inventory database 102 may collect and store a variety of data associated with one or more inventory warehouses 101a-d. For example, as illustrated in FIG. 2, client inventory database 102 may include sales order data 103, purchase order data 104, an item master list 105, inventory record data 106, and part supercession data 107.

Sales order data 103 may include data associated with a customer request for one or more parts from an inventory warehouse 101a-d. Sales order data 103 may include one or more sales order lines, each sales order line corresponding to a particular part number requested by a customer in a sales order. Thus, a sales order that includes an order for 30 part numbers may includes 30 sales order lines, each sales order line corresponding to one of the 30 part numbers. Each sales order line may include, for example, data identifying the part number requested by a customer, the desired quantity associated with the at least one part number, data indicative of a status of each sales order, and a predetermined (e.g., contracted) completion date associated with each sales order. Sales order data 103 may be loaded to and/or stored in client inventory database 102 for analysis by inventory management system 120.

Purchase order data 104 may include orders generated by an inventory warehouse, in response to a sales order. Purchase order data 104 may include, for example, an order for raw materials needed in the manufacturing of one or more parts associated with a customer order. This order may be provided by the inventory warehouse or a manufacturing facility to a third party vendor or supplier. Alternatively, purchase order data 104 may include an order to a manufacturing facility (which may or may not be part of the supply chain), requesting the manufacture of certain parts for one or more inventory warehouses 101a-d. Purchase order data may include one or more purchase order lines that specify certain requirements associated with each item in the purchase order. These requirements may be tracked by client inventory warehouse 102 during supply chain analysis processes.

Item master list 105 may include a list of part numbers (e.g., SKUs, etc.) that are stocked in one or more inventory warehouses 101a-d at a particular time. Inventory management system 120 may periodically receive/collect an updated list of parts associated with each of inventory warehouses 101a-d from a client or inventory management personnel.

Inventory record data 106 may include statistics associated with each of the parts corresponding to item master list 105. Inventory record data 106 may include information associated with each part number listed in item master list 105 such as, for example, a quantity stored in inventory, a quantity stored in each of inventory warehouses 101a-d, an inventory warehouse location (e.g., warehouse number, bin number, etc.), a price, or any other data indicative of one or more part numbers associated with item master list 105.

Part supercession data 107 may include data indicative of discontinued and/or replaced parts associated with item master list 105. Part supercession data 107 may include, for example, data indicative of part numbers that may predate, antedate, or be compatible with one or more part numbers associated with an inventory of parts. For instance, part supercession data 107 may include a list of “new” parts along with a listing of all parts with which the “new” parts may be compatible and/or supersede. Additionally, part supercession data 107 may also include a date on which the “old” part was retired from inventory. Part supercession data 107 may also include a table that lists one or more retired parts from item master list 105 along with its current replacement part.

Inventory management system 120 may include one or more software applications for determining a cause of service loss and identifying patterns of service loss associated with one or more products within a supply chain. Service loss, as the term is used herein, refers to any instance where a customer requirement of the supply chain is not met. For example, service loss may include any act or omission within the supply chain resulting in an inability to fulfill a part order by a predetermined (e.g., contracted) completion date. Inventory management system 120 may evaluate service loss and identify a cause of service loss based on a predetermined service loss hierarchy. According to one embodiment, inventory management system 120 may be configured to first assign a general category to the service loss. Once a general category has been assigned, inventory management system 120 may be configured to further analyze the service loss event to identify a subcategory with which the service loss event may be attributed.

For example, inventory management system 120 may detect a service loss event and determine that the event was caused by a failure of a third party vendor to fulfill a purchase order associated with an inventory warehouse 101a, in accordance with a predetermined (i.e., contracted) date. As a result, the inventory warehouse 101a may not be able to meet a customer sales order for one or more parts corresponding to the unfulfilled purchase order. Accordingly, inventory management system 120 may attribute the service loss to the vendor.

Inventory management system 120 and/or SLA interface 128 may further analyze the service loss caused by vendor delay to assign a sub-category, where applicable. For example, in some cases vendor delay may be based on a vendor's failure to ship the ordered parts by the date specified in the purchase order. Accordingly, inventory management system 120 may assign the sub-category of “overdue purchase order” (or “OVPO”) to the vendor delay.

On the other hand, vendor delay may be based on a transit delay from the vendor's facility to the inventory warehouse. For example, when a vendor ships a part from the vendor facility, the vendor typically provides an advanced shipping notification (ASN) to the inventory warehouse, indicating that the parts have been shipped from the vendor facility and should arrive at the inventory warehouse in accordance with the date specified in the purchase order. Should the order not reach the inventory warehouse by the purchase order date, inventory management system 120 may attribute the vendor delay to a transit delay. In response, inventory management system 120 may assign the sub-category of ASN to the vendor delay.

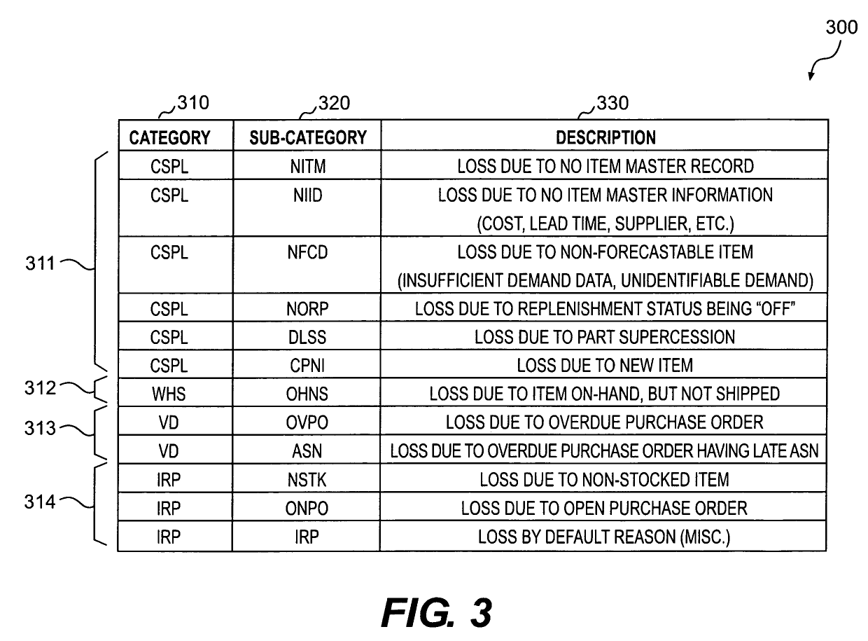

FIG. 3 provides a table illustrating a sample loss reason hierarchy 300 used by inventory management system 120 to assign service loss causes to a particular service loss event. As illustrated in FIG. 3, loss reason hierarchy 300 may include a plurality of categories 310, each category including at least one sub-category 320 and a description 330 associated therewith. Those skilled in the art will recognize that additional, fewer, and/or different loss reason hierarchy formats may be employed, depending upon a customer request. For example, organizations that employ third party logistics providers for supply chain management may require additional categories and sub-categories for service loss management in order to determine whether the third party logistics provider is performing in accordance with a service agreement, whether the service loss was caused by a vendor, or whether the service loss may be caused by an organization's internal processes. Alternatively and/or additionally, organizations that manage their own supply chain may require fewer subcategories, as these organizations may only be concerned with differentiating between internal supply chain errors and those caused by external vendors or suppliers.

Categories 310 may include one or more primary reasons that may be attributed to service loss. As illustrated in FIG. 3, categories 310 may include one or more facilities, organizations, or policies that may be a source of service loss in the supply chain. For instance, service loss may be caused by one or more internal errors associated with facilities or organizations such as inventory warehouses 101a-d or external vendors and may be characterized as warehouse (“WHS”) 312 or vendor (“VD”) 313 causes, respectively. Alternatively, service loss may be attributed to one or more internal inventory policies of a client or facility, such as a client service policy (“CSPL”) 311 or replenishment policy (“IRP”) 314. It is contemplated that additional, fewer, and/or different service loss categories may be used. Furthermore, it is contemplated that one or more categories may be assigned to capture generic supply chain loss (e.g., a “supply chain” loss category) associated with one or more generic loss reasons.

Each of categories 310 may include at least one sub-category 320 for further characterizing a service loss event. Each subcategory may be accompanied by a description 330, which provides an explanation for the subcategory to the user via a service loss report. For example, the CSPL category 311 may include a plurality of subcategories, each of which assigns a specific reason for the service loss due to the client service policy. Thus, a service loss event code of CSPL/DLSS, corresponds to a service loss event attributed to a client service policy that is due to part supercession, indicating that a sales order was unfulfilled because the part number ordered by the customer was superseded by a “new” part in the client's inventory. Accordingly, when the client receives a customer order for superseded parts and the part cannot be fulfilled from inventory by the predetermined completion date, the loss is subsequently assigned to the DLSS subcategory.

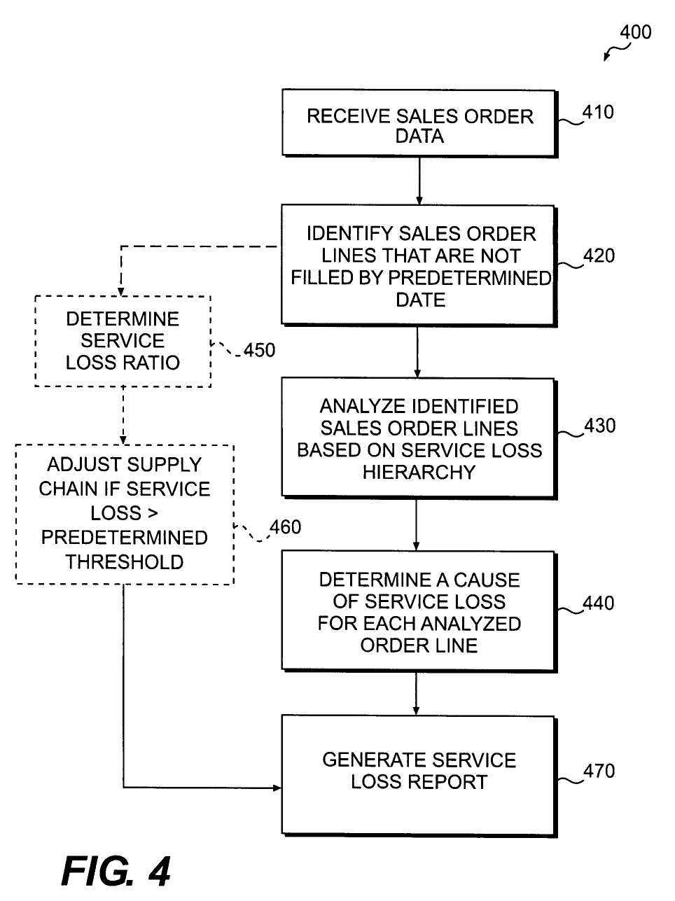

Inventory management system 120 may include a software application that tracks inventory data (either real-time or in batches at predetermined intervals) associated with a supply chain, monitors the data to identify failures in meeting customer orders, and determines the cause of these failures. According to one embodiment, the software may generate reports that summarize the service loss analysis and provide recommendations for mitigating the effects of service loss. FIG. 4 provides a flowchart 400 that depicts an exemplary method for service loss analysis and reporting performed by inventory management system 102 and/or software associated therewith.

As illustrated in FIG. 4, inventory management system 120 may receive/collect one or more sales orders associated with one or more customers (Step 410). For example, inventory management system 120 may request inventory management data from one or more client inventory databases 102 and receive the data in response to the request. Alternatively and/or additionally, inventory management system 102 may receive and/or collect inventory management data from one or more client inventory databases 102 periodically, in accordance with a predefined service loss analysis schedule.

As explained, each sales order may include one or more sales order lines. Each sales order line may identify one or more customer requirements associated with a part order. For example, sales order lines may identify a requested part by part number (e.g., SKU), a desired quantity of the part number, a desired completion date (e.g., ship date, receipt date, etc.) for the part number, a shipping location for the part number, or any other suitable requirement from a customer (e.g., shipping method, shipping urgency, etc.).

Inventory management system 120 may identify sales order lines that are not filled by a predetermined completion date (Step 420). According to one embodiment, inventory management system 120 may monitor a status of all open sales order lines associated with client inventory database 102. Sales order status information may be updated by inventory personnel periodically, as the order progresses through the supply chain. If the predetermined completion date for the sales order line has passed and the order has not been filled, inventory management system 120 may track the status of the part number to be “Backordered.” On the other hand, if the sales order line has been filled on or before the predetermined completion date, inventory management system 120 may track the status as “Complete.” Inventory management system 120 may flag all backordered lines for further service loss analysis to identify a cause associated with the failure to fulfill the customer order. The determination of backorder or complete is configurable where each client can make the determination of how to classify whether a line is backordered or shipped.

Once backordered lines have been identified, inventory management system 120 may analyze the backordered lines based on a service loss reason hierarchy (Step 430). For example, inventory management system 120 may compare the status of each backordered line with a predetermined service loss reason database such as, for example, the loss reason hierarchy illustrated in FIG. 3. Accordingly, inventory management system 140 may identify a cause of service loss for each backordered order line (Step 440). According to one embodiment, inventory management system 120 (and/or SLA interface 128) may categorize the service loss as one of a client service policy loss (CSPL), a warehouse loss (WHS), a vendor delay loss (VD), or an inventory replenishment policy loss (IRP). Additionally, inventory management system 120 may further categorize the service loss reason if the status of the backordered line conforms to the requirements of a particular subcategory.

By way of example, inventory management system 120 may receive a sales order from a customer. In filling the customer order, however, an inventory manager may notice that the item master list 105 does not include a retail price to charge customers. Should the sales order line associated with this part number be delayed during the resolution of this discrepancy, resulting in a service loss event, inventory management system 120 may attribute the service loss to category CSPL (client service policy loss), subcategory NIID (No Item Indicative Data), indicating that the loss was due to insufficient data contained in the item master list.

In addition to identifying and assigning a reason for the service loss to backorder sales order lines, inventory management system may determine a service loss ratio for one or more inventory warehouses 101a-d or an entire supply chain (Step 450). The service loss ratio may be calculated as the ratio of sales order lines that have not been completed by the predetermined completion date to the total number of sales order lines received. Piece loss is determined as the ratio of total number of products that are not filled on or before a predetermined completion date to the total number of products ordered for all received sales order lines. Line loss is determined as the ratio of total number of lines (each line containing a number of pieces requested by a customer) that are not filled on or before a predetermined completion date to the total number of lines received in all sales orders. Order loss is determined as the ratio of the total number of orders not completed (each order containing a plurality of sales order lines requested by a customer, each line containing one or more pieces) that are not filled on or before a predetermined completion date to the total number of orders received. Total order loss is the summation of all orders for a predetermined period of time (day, week, month, etc.).

Accordingly, if 40 sales order lines failed to be completed during an analysis period that received 1200 sales orders, the service loss ratio for the analysis period may be determined as 40/1200, or 3.3%. Piece fill will also be calculated as the ratio of products order for each sales order line that have not been completed by the predetermined completion date to the total number of products ordered for all sales order lines received. Accordingly, if 10 products were ordered for line 1 of the sales order and we were able to fill 8 of these products while 20 products were ordered for line 2 of the sales order and we were able to fill 18 of these products, the service loss piece ratio for the analysis period may be determined as 4/30 or 13.3%. Order fill will also be calculated as the ratio of orders filled completely by the predetermined completion date to the total number of orders received. Accordingly, if order 1 was completely filled, order 2 was not completely filled, and order 3 was completely filled, the service loss order ratio for the analysis period may be determined as ⅓ or 33.3%.

According to one embodiment, inventory management system 120 may be configured to analyze the service loss ratio and adjust one or more operational aspects associated with the supply chain if the service loss ratio exceeds a predetermined acceptable limit (Step 460). For example, inventory management system 120 may increase a safety stock level associated with one or more part numbers in inventory, particularly those that may be associated with increased service loss levels. By increasing safety stock for certain “problem” part numbers, inventory management system 120 may ensure that an appropriate quantity of one or more part numbers remain on-hand to meet customer demand, thereby limiting service loss. Alternatively, if a service loss is caused by a particular supplier (e.g., product vendor or transit company) inventory management system 120 may recommend changing suppliers or transit companies.

Inventory management system 120 may generate a service loss report summarizing the service loss analysis, causes associated with service loss, service loss ratio (at a line, piece, and order level), adjustments made to supply chain environments in response to service loss, the status of backordered items, or any other data related to service loss. According to one embodiment, a user may customize the report by selecting desired analysis data to be contained in the report. Alternatively and/or additionally, inventory management system 120 may display a list of analysis parameters and/or pre-designed report formats via SLR interface for selection by the user. For example, users may select a report format that summaries service loss for a desired period of interest to a user. According to another example, a user may select a report format that summarizes service loss statistics by category, age of backorder, part numbers containing the largest number of backorders, vendor, order type, or any other suitable criteria. Inventory management system 120 may provide the report to one or more I/O devices 126 for deliver to a user.

Although certain embodiments discussed above describe inventory management system 120 as a separate stand-alone system, it is contemplated that inventory management system 120 may include a plurality of systems integrated within one or more computer systems associated with each of inventory warehouses 101a-d. Moreover, although inventory management system 120 is described as a computer hardware system, inventory management system 120 may embody a software program that may be loaded and executed on one or more computer systems within a supply chain environment, without requiring its own computer hardware components.

### INDUSTRIAL APPLICABILITY

Although the disclosed embodiments are described in connection with supply chain management processes for hardware equipment in inventory warehouse environments, they may applicable to any environment where it may be advantageous to minimize a loss of service to the customer. Specifically, the systems and methods described herein may enable inventory managers to analyze service loss events, identify reasons for the service loss event, provide user-customizable reports associated with service loss analysis, and, in some cases, adjust aspects of the supply chain to mitigate the effects of service loss.

The presently disclosed system and method for service loss analysis and reporting may increase supply chain reliability and efficiency. For example, the systems and methods described herein are configured to determine causes of service loss, rather than merely monitoring service levels and reporting changes in the service levels, as in some conventional systems. Accordingly, the presently disclosed systems and methods may enable inventory managers and logistics providers to quickly isolate problematic sources of service loss and take necessary action to mitigate these problems. Additionally, because the presently disclosed systems may require less investigation on the part of inventory managers to isolate causes of service loss, inventory management time and resources may more appropriately directed toward mitigating the affects of service loss and providing long-term solutions for correcting supply chain errors that cause service loss.

It will be apparent to those skilled in the art that various modifications and variations can be made to the presently disclosed system and method for service loss analysis and reporting. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for analyzing service loss in inventory environments, comprising:
receiving sales order data associated with a plurality of warehouses, the sales order data having at least one sales order line that includes data indicative of a customer requirement associated with a part number;
analyzing sales order lines that are not filled by a predetermined completion date based on a predetermined service loss hierarchy;
determining a cause of service loss for one or more sales order lines that are not filled by a predetermined completion date based on the analysis; and
generating a service loss report summarizing the cause of service loss for the one or more sales order lines that are not filled by a predetermined completion date.

2. The method of claim 1, wherein receiving sales order data associated with a plurality of warehouses includes:
querying an inventory database associated with each of the plurality of warehouses; and
receiving sales order data from each of the inventory databases in response to the query.

3. The method of claim 1, wherein each sales order line includes data indicating one or more of at least one part number requested by a customer, a desired quantity associated with the at least one part number, data indicative of a status of each sales order, and the predetermined completion date associated with each sales order.

4. The method of claim 1, wherein receiving sales order data further includes:
determining whether a part associated with a sales order line has shipped to a customer on or before the predetermined completion date;
tracking the status of the sales order line as “complete” if each part associated with the sales order line has shipped to a customer on or before the predetermined completion date; and
tracking the status of the sales order line as “backorder” if each part associated with the sales order line has not shipped to the customer on or before the predetermined completion date.

5. The method of claim 1, further including determining the service loss as a ratio of a total number of sales order lines that are not shipped on or before the predetermined completion date to a total number of received sales order lines.

6. The method of claim 5, further including increasing a safety stock level for one or more part numbers associated with the service loss based on the service loss ratio.

7. The method of claim 1, further including:
identifying one or more parts associated with a sales order line that are not shipped on or before the predetermined completion date; and
determining a piece loss ratio for the sales order line as a number of parts that are not shipped on or before the predetermined completion date to a total number of parts associated with the sales order line;
wherein the sales order line is identified as containing a service loss event if every part associated with the sales order line is not shipped on or before the predetermined completion date.

8. The method of claim 1, further including determining one or more of a piece loss ratio or an order loss ratio associated with one or more sales orders associated with a plurality of inventory warehouses.

9. The method of claim 1, wherein the report includes recommendations for adjusting one or more aspects of a supply chain to mitigate the cause of service loss.

10. The method of claim 1, wherein determining the cause of service loss includes analyzing the sales order lines that are not filled by a predetermined completion date based on a predetermined loss reason hierarchy; and
attributing the cause of service loss to one or more of a warehouse error, an inventory management error, a vendor error, or a client specified reason in response to the analysis.

11. A method for inventory management based on service loss, comprising:
receiving sales order data associated with a plurality of warehouses, the sales order data having at least one sales order line that includes data indicative of a customer requirement associated with a part number;
determining a status of each sales order line based on the sales order data;
determining a service loss as a ratio of a total number of sales order lines that are not filled on or before a predetermined completion date to the total number of received sales order lines; and
adjusting an operational aspect of the supply chain if the service loss ratio exceeds a predetermined threshold level.

12. The method of claim 11, further including:
analyzing sales order lines that are not filled by a predetermined completion date to determine a cause of service loss associated with each of the one or more sales order lines; and
generating a report summarizing the cause of service loss for each of the identified sales order lines.

13. The method of claim 12, wherein determining the cause of service loss includes
analyzing sales order lines that are not filled by a predetermined completion date based on a predetermined loss reason hierarchy; and
attributing the cause of service loss to one or more of a warehouse error, an inventory management error, a vendor error, or a client specified reason in response to the analysis.

14. The method of claim 12, wherein the report includes recommendations for adjusting one or more aspects of a supply chain to mitigate the cause of service loss.

15. The method of claim 11, wherein receiving sales order data associated with a plurality of warehouses includes:
querying an inventory database associated with each of the plurality of warehouses; and
receiving sales order data from each of the inventory databases in response to the query.

16. The method of claim 11, wherein adjusting the operational aspect includes increasing a safety stock level associated with one or more part numbers associated with sales order lines that are not filled on or before a predetermined completion date.

17. The method of claim 11, wherein determining a status of the at least one sales order line includes:
determining whether a part associated with a sales order line has shipped to a customer on or before the predetermined completion date;
tracking the status of the sales order line as “complete” if each part associated with the sales order line has shipped to a customer on or before the predetermined completion date; and
tracking the status of the sales order line as “backorder” if each part associated with the sales order line has not shipped to the customer on or before the predetermined completion date.

18. An inventory management system comprising:
a service loss analysis interface configured to:
receive sales order data associated with a plurality of warehouses, the sales order data having at least one sales order line that includes data indicative of a customer requirement associated with a part number;
analyze sales order lines that are not filled by a predetermined completion date based on a predetermined service loss hierarchy;
determine a cause of service loss for one or more sales order lines that are not filled by a predetermined completion date based on the analysis; and
a service loss reporting interface configured to:
prompt a user to select one or more service loss reporting formats and a service loss reporting frequency;
receive the user selections; and
generate a service loss report in accordance with the user selections, the service loss report summarizing the cause of service for one or more sales order lines that are not filled by the predetermined completion date.

19. The system of claim 18, wherein determining the cause of service loss includes
analyzing the sales order lines that are not filled by a predetermined completion date based on a predetermined loss reason hierarchy; and
attributing the cause of service loss to one or more of a warehouse error, an inventory management error, a vendor error, or a client specified reason in response to the analysis.

20. The system of claim 18, further including:
determining the service loss as a ratio of a total number of sales order lines that are not shipped on or before the predetermined completion date to the total number of received sales order lines; and
adjusting an operational aspect of the supply chain if the service loss ratio exceeds a predetermined threshold level.
